(19) United States
(12) Patent Application Publication
(10) Pub. No.: US 2015/0238888 A1
(43) Pub. Date: Aug. 27, 2015

(54) APPARATUS FOR REMOVING PARTICULATE FROM A FILTER

(71) Applicant: Thomas A. COMEAU, Vista, CA (US)

(72) Inventor: Thomas A. COMEAU, Vista, CA (US)

(21) Appl. No.: 14/189,109

(22) Filed: Feb. 25, 2014

(51) Int. Cl. B01D 46/00; B01D 46/44

(52) U.S. Cl. CPC B01D 46/0068; B01D 46/444

(57) ABSTRACT

An apparatus for removing particulate from a filter comprises a blower housing and at least one fluid hose comprising a proximal end and a distal end. The proximal end operatively connects to the blower housing. The distal end operatively connects to a nozzle. A filter housing in fluid communication with the nozzle is provided and configured to receive a filter. The apparatus further comprises a particulate containment mechanism configured to receive and store particulate from the filter received by the filter housing. A flow meter is provided and configured to measure flow rate of fluids drawn therethrough, wherein the blower housing causes fluids to be drawn through that at least one fluid hose and remove particulate from the filter received by the filter housing.

### FIELD

The present disclosure relates to an apparatus and method for cleaning filters with accumulated undesirable particulate such as ash or soot. In certain embodiments, the filter being cleaned is a diesel particulate filter (DPF) for a motor vehicle and cleaning is accomplished by removing soot from the DPF. The present disclosure also relates to particulate management systems used in industrial work places such as manufacturing plants with ventilation of airborne particulates and the like.

### BACKGROUND

Exhaust in diesel motors is particulate or waste known commonly as soot. Present diesel motors use filters that remove this waste including soot, ash, particulate or the like (hereinafter “waste”). This waste is a byproduct in the combustion process of typical motors. In presently used filters, this waste remains in the filter where it accumulates. Conventional DPFs are designed to remove this waste from the exhaust produced by the diesel motor without impeding the exhaust flow from the motor. However, over time waste tends to accumulate in the DPF which in turn causes the diesel motor to become less efficient. To resolve this, the DPF is either replaced or waste accumulated therein is removed.

Because replacing the DPF is costly and otherwise wasteful in regards to resources, operators typically opt to remove the waste from the DPF. Current approaches to waste removal from DPFs include regeneration. Regeneration involves oxidation of the accumulated waste but suffers from being time consuming and an unnecessary risk in safety to the user removing the particulate. Significantly, not all particulates are combustible and thus are impossible to remove during regeneration such as metal oxides (e.g. ash). Accordingly there is a need to provide an apparatus and method to remove combustible and non-combustible waste from filters.

Other approaches to waste removal from DPFs include utilization of blowers. However, current approaches fail to adequately contain waste after it is removed from the filter as well as waste such as ash that is particularly ensnared in the DPF. To address the issue of removing particularly ensnared waste, operators have been know to employ liquid solvents to remove the ensnared waste but such use can lead to decreasing the efficiency of the filter. Accordingly, there is a need to provide an apparatus that removes particularly ensnared waste without solvents and without harming the efficiency of the apparatus.

In settings where industrial processes are performed, significant amounts of waste are produced. This waste must be ventilated from the work area. Typical ventilation systems utilize filters to remove the waste. However, similar to above, over time waste accumulate in the filters such that the waste must be similarly removed from the filter before the filters can then be used.

Therefore, it would be advantageous to develop an apparatus and/or system to efficiently and easily remove waste that accumulates in filters without having to employ regeneration means incapable of removing all waste, solvents that are detrimental to overall efficiency, or blowers without particulate containment mechanisms. It would be further advantageous if the apparatus and/or system were efficient in such a way that it reduced the current misuse of resources otherwise devoted towards removing waste in filters and/or creating new filters so that motors or industrial processes could continue to serve society.

### SUMMARY

The concepts disclosed herein resolve the foregoing problems by providing an apparatus and method of removing waste such as particulate, soot, and ash from a DPF with ease and efficiency.

In some embodiments, the apparatus comprises a blower housing and at least one fluid hose comprising a proximal end and a distal end. The proximal end operatively connects to the blower housing. The distal end operatively connects to a nozzle. A filter housing in fluid communication with the nozzle is provided and configured to receive a filter. The apparatus further comprises a particulate containment mechanism configured to receive and store particulate from the filter received by the filter housing. A flow meter is provided and configured to measure flow rate of fluids drawn therethrough, wherein the blower housing causes fluids to be drawn through that at least one fluid hose and remove particulate from the filter received by the filter housing.

The blower housing may further comprise a motor and a blower fan, wherein the motor causes the blower fan to rotate. Rotating the blower fan causes fluids to be drawn through the at least one fluid hose. A particulate removal display may be provided and configured to indicate that particulate has been removed from the filter to a pre-determined level. The particulate removal display in some embodiments is a visual window disposed between the filter housing and the nozzle. The visual window is configured to provide visual indication that particulate is being removed in real-time.

An external supply of fluids may be provided in fluid communication with the filter housing causing the filter housing to become pressurized. In some embodiments, a pressure adjustment mechanism is provided and configured to adjust pressure of the filter housing.

A plurality of wheels may be provided and mechanically attached to the blower housing such that the apparatus is easily transportable. When the flow meter measures a pre-determined flow rate, a user or the like is alerted that particulate has been sufficiently removed from the at least one filter securely positioned in the filter housing.

The filter to be received and securely positioned in the filter housing is a diesel particulate filter or a filter configured for use in a ventilation system. A particulate containment mechanism may be a bag or reservoir disposed in the blower housing. The particulate containment mechanism may be a blower filter disposed in the blower housing.

The apparatus may be configured to be portable through a plurality of wheels disposed underneath blower housing. Accordingly, the apparatus is storable which conserves vital storage resources in the typical shop environment. Portability of the apparatus provides a user the ability to utilize the apparatus in multiple locations.

In another embodiment, an apparatus for removing particulate from a filter comprises a blower housing and at least one fluid hose comprising a proximal end and a distal end. The proximal end of the at least one fluid hose is operatively connected to the blower housing. A nozzle is operatively connected to the distal end of the at least one fluid hose. A filter housing is provided and configured to receive a filter, wherein the filter housing is in fluid communication with the nozzle. A particulate containment mechanism is provided and configured to receive and store caused to be removed by the fluid drawn through the at least one fluid hose. A particulate removal display is provided and configured to provide indication to a user that particulate has been removed from the filter to a pre-determined level such that the blower housing causes fluids to be drawn through that at least one fluid hose and remove particulate from the filter positioned in the filter housing.

The blower housing comprises a motor and a blower fan, wherein the motor causes the blower fan to rotate, and wherein rotating the blower fan causes fluids to be drawn through the at least one fluid hose. A flow meter is provided and configured to measure flow rate of fluids drawn through the fluid hose. When the flow meter measures a pre-determined flow rate, particulate has been sufficiently removed from the at least one filter. In some embodiments, the particulate removal display is a visual window disposed between the filter housing and the nozzle, wherein the visual window is configured to provide visual indication that particulate is being removed in real-time.

In other embodiments, a method is provided for removing particulate from a filter comprising: providing an apparatus as described herein, securely positioning at least one filter in the filter housing, activating the motor of the blower housing causing fluids to be drawn from the at least one hose through the filter; and removing particulate from the at least one filter with the fluids drawn through that least one hose. The at least one filter securely positioned in the filter housing may be a diesel particulate filter or a filter configured for use in a ventilation system. The method may further comprise introducing a source of compressed air to pressurize the filter housing

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 depicts a side view depicting on embodiment of the apparatus for removing waste from a filter.

FIG. 2 depicts one embodiment of the blower housing of FIG. 1.

FIG. 3 is an exploded view of the blower housing depicted in FIG. 2.

FIG. 4 depicts a perspective view of the apparatus for removing waste from a filter.

### DETAILED DESCRIPTION

As used herein, “fluids” refers to a substance that has no fixed shape and yields easily to external pressure such as a gas or a liquid.

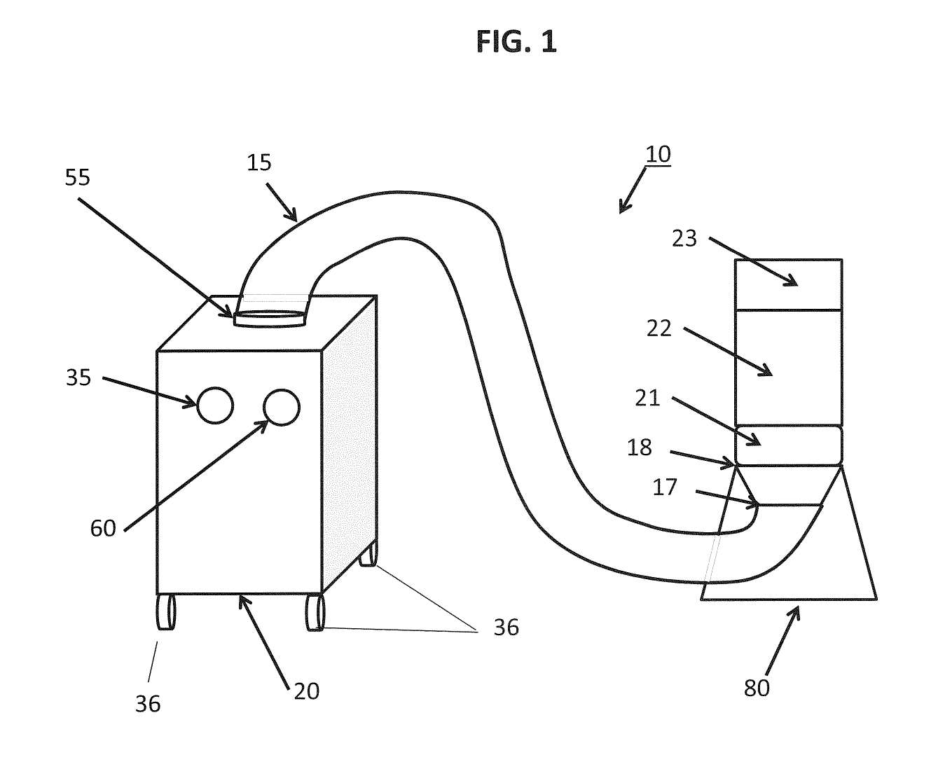

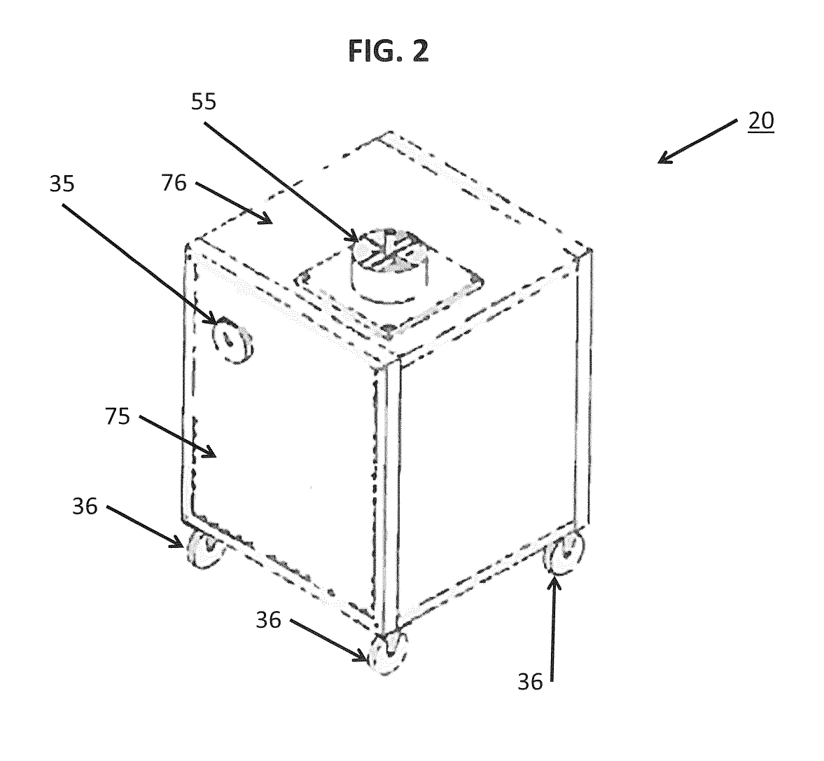

FIG. 1 depicts one embodiment of the apparatus and system 10 for removing particulate from a filter 50. A blower housing 20 is provided and is a hollowed structure which is constructed in any shape such as rectangular, circular, cylindrical, spherical, elliptical, or the like. It may be integrally formed such as through molded construction with uniform materials or a composite blend of materials. In other embodiments, housing 20 is a composite assembly of different panels interconnected through fastening mechanisms and support beams as depicted in FIG. 2. In a preferred embodiment, blower housing 20 is a fourteen gauge welded steel cabinet with wheels 36 mechanically connected thereto underneath. Wheels 36 may be pneumatic castors.

Blower housing 20 is mechanically connected to fluid hose 15 at inlet 55 (described more particularly below), wherein fluid hose 15 comprises a proximal and a distal end each configured to provide fluid communication to a fluid connector such as inlet 55 or nozzle 17. Disposed inside blower housing 20 is motor 30 and blower fan 45. Motor 30 and blower fan 45 operatively connect to cause fluid to be drawn through fluid hose 15 from inlet 55 to filter housing 22 as described more particularly below. Filter housing 22 is configured to receive any DPF publicly available (described more particularly below).

Turning to FIG. 2, one embodiment of blower housing 20 is provided showing components disposed therein. Blower housing 20 is depicted comprising starter 35 disposed on a front face 75 of housing 20. However, starter 35 may be disposed on any of the other outer faces of housing 20 and/or may be detachable according to design needs. Inlet 55 is disposed on the upper face 76 of housing 20 but may be disposed on any of the other outer faces of housing 20. Inlet 55 may be detachable, wherein inlet 55 comprises a collar configured to mechanically attach to the upper surface 76 of housing 20. In other embodiments, inlet 55 and collar are integrally formed with housing 20 on the face to which it is disposed.

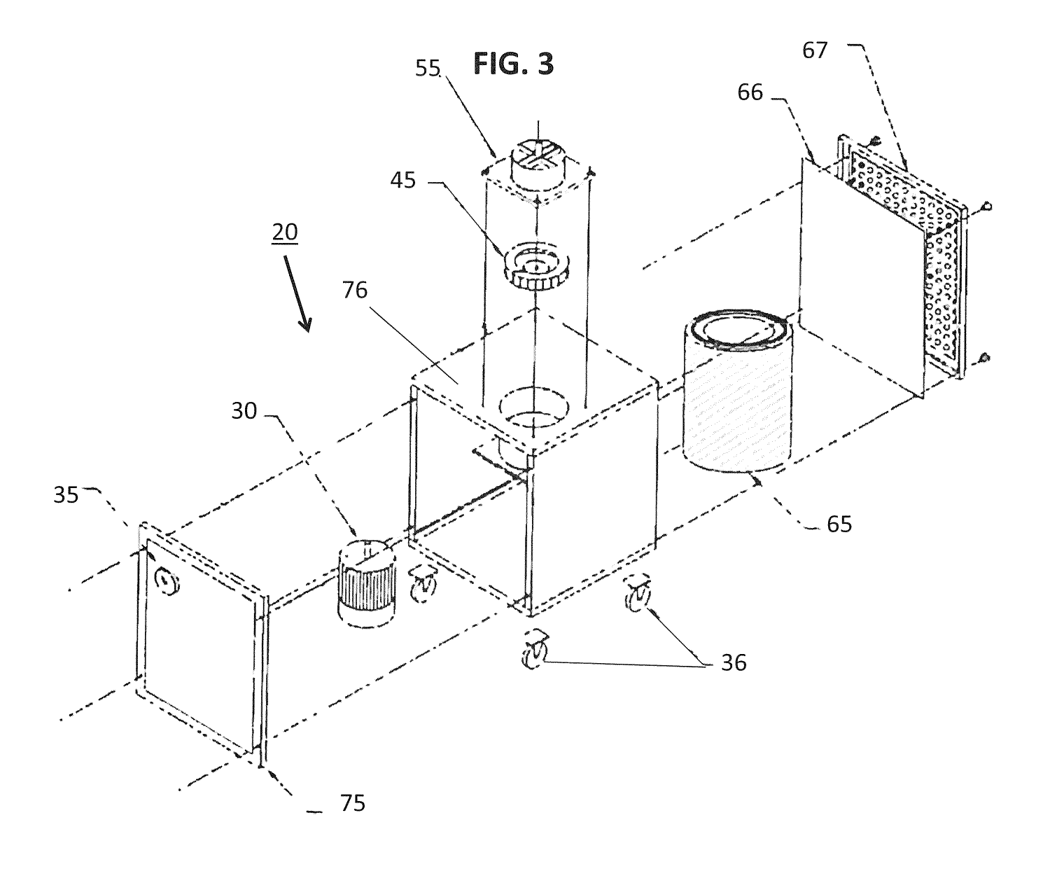

Motor 30 (depicted in FIG. 3) is disposed inside blower housing 20 such that it mechanically connects to starter 35. In a preferred embodiment, starter 35 is a rotary motor starter with activation switch. Before activating apparatus 10, blower filter 65 is positioned in blower housing 20 and activation switch of starter 35 is activated causing motor 35 to engage blower fan 45 and draw fluids through hose 15. Blower housing 20 and/or blower filter 65 are configured to collect waste removed from filter 50 when apparatus 10 is used. Blower housing 20 may further comprise a bladder, reservoir, or bag configured to receive and store waste removed from filter 50 during use. As seen in FIG. 3, blower fan 45 is disposed adjacent to inlet 55, wherein inlet 55 is configured to receive proximal end of fluid hose 15. Once motor 30 activates, fluid is caused to be drawn by blower fan 45 through inlet 55 into fluid hose 15.

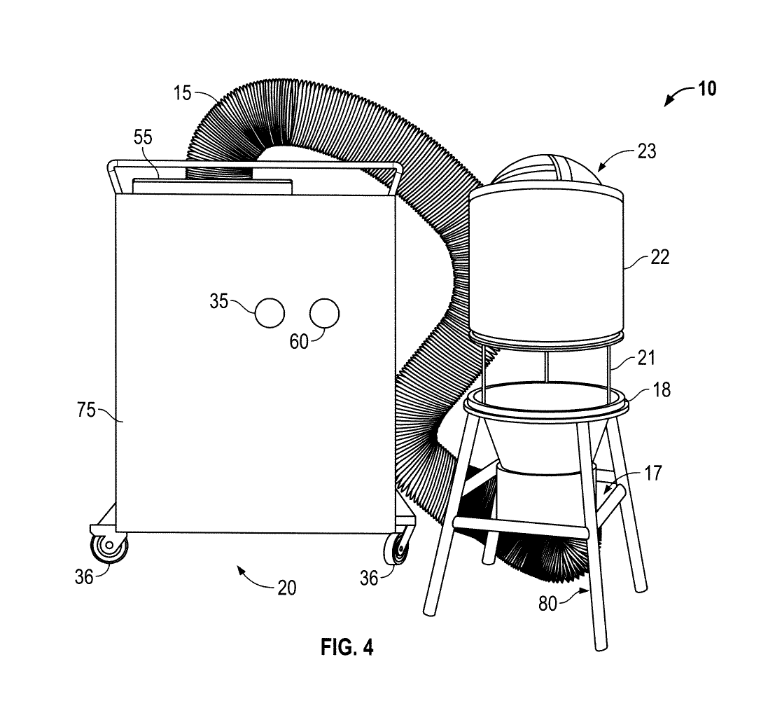

FIGS. 1 and 4 illustrate distal end of fluid hose 15 operatively connecting to nozzle 17. Nozzle 17 comprises an upper surface 18 operatively connected to filter housing 22 which is configured to receive filter 50 which is a DPF or the like. A particulate display 21 may be disposed between filter housing 22 and nozzle 17. A particulate containment mechanism 23 may be provided and mechanically attached to filter housing 22. Particulate containment mechanism 23 is depicted being disposed above filter housing 22 whereas in other embodiments, particulate containment mechanism 23 is disposed underneath or along side filter housing 22. Particulate containment mechanism 23 is configured to receive and store waste as previously described. Once filter 50 is positioned in filter housing 22 and motor 30 is activated, waste accumulated in filter 50 is removed by the drawn fluids from fluid hose 15 and captured by blower filter 65 and/or particulate containment mechanism 23. Activation of blower housing 20 causes fluids to be introduced into filter housing 22 and therefore filter 50. Upon introducing fluids into filter 50, waste is dislodged from mesh and/or layers of filter 50 and therefore removed.

Fluids may be drawn from an external fluid supply such as shop or compressed air introduced through filter housing 22 or blower housing 20 while fluids are pulled from filter housing 22 to the blower housing 20 by blower fan 45 when motor 30 is activated. Introducing fluids from the external fluid supply causes the fluid housing 22 to become pressurized. Introducing fluids into fluid housing 22 causes waste accumulated in filter 50 to be extricated or displaced and drawn towards blower filter 65. However, in other embodiments the waste is extricated or displaced and drawn towards particulate containment mechanism 23. In certain embodiments, introduction of fluids results in cell by cell concentration of fluids and relatively high pressure flow of fluids directed at cells in a mesh comprised in filter 50.

Instead of particulate containment mechanism 23, filter housing 22 may comprise a sealed or closed upper end and an open lower end with at least one wall or a plurality of walls disposed therebetween. Open lower end therefore is in fluid communication with nozzle 17 and hose 15. Filter housing 22 may further comprise a pressure meter wherein the pressure meter is mechanically connected to one wall of filter housing 22. Pressure meter is configured to detect the internal fluid pressure of the filter housing 22 and in certain embodiments is configured to adjust the internal fluid pressure. For example, when internal fluid pressure reaches a pre-determined value, a valve is provided to vent fluids disposed in filter housing 22 and direct said fluids to ambient air.

A waste filter positioning mechanism configured to maintain the one or more filters 50 in a substantially secured position is provided and disposed internal to filter housing 22. In some embodiments, waste filter positioning mechanism is detachable or integrally formed with filter housing 22 and disposed underneath filter 50 when filter 50 is positioned in blower housing 20. Waste filter positioning mechanism may instead be configured to secure filter 50 from above through a hook or retainment mechanism affixed to the upper end of filter housing 22.

Particulate removal display 21 may be a visual window disposed below filter housing 22. Display 21 is configured to provide visual indication to users that waste is being removed from the filter 50 in real-time.

Blower filter 65 may comprise a plurality of panels constructed from polyester or any other suitable materials. The plurality of panels may also be impregnated with activated carbon to filter predetermined odors present in ambient air. In some embodiments, a second blower filter is provided and configured to remove up to 0.3 microns of waste.

In a preferred embodiment, the diameter of inlet 55 is six inches. However, the diameter of inlet 55 may be greater or less than six inches according to design preference and needs. In a preferred embodiment, fluid hose 15 measures approximately eight feet in length. However, the length of fluid hose 15 may be greater or less than eight feet. Fluid hose 15 may be detachable or integrally formed with blower housing 20. In some embodiments, fluid hose 15 is an articulated duct. Further, more than one fluid hose may be provided in order to provide particular removal capabilities to more than one filter housing 22.

In a preferred embodiment, motor 30 is configured to generate at least 1.5 HP. However, motor 30 may generate more or less than 1.5 HP according to design needs or preferences. Motor 30 is configured to run on standard 110V single phase power and blower fan 45 operatively connected thereto is configured to utilize an external source for compressed air. However, in other embodiments, motor 30 is configured to run on different power settings and blower fan operates without a source for compressed air.

In a preferred embodiment, apparatus 10 as arranged with the components described herein is configured to draw a volumetric flow rate of approximately 1,200 ft³/min. However, apparatus 10 may be configured to draw a volumetric flow rate of more or less than 1,200 ft³/min according to design needs and preferences. Further, blower housing 20 may be provided with flow adjustment mechanism, wherein the volumetric flow rate of fluids being drawn through fluid hose 15 is adjustable by modulating speed of blower fan 45. In some embodiments, blower fan 45 is backward inclined.

In some embodiments, blower housing 20 comprises a door 66 through which blower filter 65 is detachable. Door 66 comprises a locking mechanism configured to seal blower housing 20 and provide capabilities to remove and insert blower filter 65. A blower filter positioning mechanism configured to maintain blower filter 65 in a substantially secured position is provided and disposed internal to blower housing 20. In some embodiments, filter positioning mechanism is detachable or integral with blower housing 20 and disposed underneath blower filter 65 when blower filter 65 filter is positioned in blower housing 20. When blower filter 65 is ready to have particulate removed, motor 30 may be activated to remove waste from filter 50 now positioned in filter housing 22.

Mesh panel 67 may be detachable from apparatus 10 and new panels are installable as required. Mesh panel 67 is configured to absorb gases and odors from the drawn fluid. Additional panels or replacement panels can be installed by applying a small amount of contact cement, adhesives, bonding, sonic welding, or the like on an outside edge of the panel 67 facing the door 66.

FIGS. 1 and 4 each depict one embodiment of apparatus 10 where blower housing 20 comprises flow meter 60 being positioned on forward face 75. Alternatively, flow meter 60 is disposed on hose 15, filter housing 22, or any other location on apparatus 10 according to design needs or preferences. In operation, filter 50 is positioned in filter housing 22 until flow meter 60 operatively connected thereto reads a predetermined flow rate. In the embodiments where the flow meter is a Minihelic® pressure gauge in fluid communication with apparatus 10, the predetermined value is between 0 to 0.5 inches wc. In this embodiment, once the flow meter 60 attains a predetermined value according to design needs, apparatus 10 may be deactivated and filter 50 may be removed from filter housing 22 since filter 50 is now ready to be used once more in its intended design use. In other embodiments, flow meter 60 is Magnehelic® gauge, Photohelic® gauge, or the like.

In other embodiments, blower housing 20 is configured to be transported through a plurality of wheels 60 mechanically attached to the lower surface of blower housing 20. Wheels 60 may be rotatable and/or pneumatic castors. Wheels 60 provide an operator the ability to easily transport and thus easily store apparatus 10 when not in use.

In some embodiments, blower filter 65 is a particulate containment mechanism employed by apparatus 10 to capture waste removed from filter 50. Blower filter 65 therefor should be replaced or cleaned as required when the flow meter 60 reads a pre-determined value. In other embodiments, a filter cartridge of blower filter 65 should be replaced or cleaned when suction of fluids caused to be drawn through the blower filter 65 is insufficient (e.g. fluid flow is relatively decreased).

Blower housing 20 of FIG. 4 is provided with a plurality of caster wheels 65 disposed underneath. Flow meter 60 and starter 35 are depicted being arranged on front face 75 of housing. Inlet 55 comprising a collar is depicted positioned on the upper surface of blower housing 20 and both mechanically connected and in fluid communication with proximal end of fluid hose 15. Filter housing 22 is provided adjacent to blower housing 20. Particulate containment mechanism 23 is mechanically connected to filter housing 22, wherein particulate containment mechanism 23 in this embodiment is disposed above filter housing 22.

In a preferred embodiment, particulate display 21 is a window through which waste being removed from filter 50 positioned in filter housing 22 can be seen as the waste is removed during operation of apparatus 10. In a preferred embodiment, window is constructed from acrylic or the like. Accordingly, display 21 is operatively connected to the underside of filter housing 22 and to the upper surface of nozzle 17. Fluid hose 15 provides a sealed fluid bridge between inlet 55 of blower housing 20 and nozzle 17 such that fluids drawn between blower fan 45 of blower housing 20 causing waste to be removed from the one or more filters 50 in filter housing 22. When one or more filters 50 are positioned in filter housing 22 and motor 30 is activated, fluids are drawn from blower fan 45 through hose 15.

Particulate display 21 is configured so that as fluids are drawn from activated blower fan 45, waste being removed from filter 50 is seen through display 21 from outside apparatus 10. In other embodiments, display 21 is not provided and instead indication that waste has been removed from filter 50 is provided by flow meter 60 attaining pre determined value as previously described. In all embodiments, once a predetermined amount of waste is obtained as verified by viewing display 21 and/or flow meter 60, filter 50 is capable of being used once more in its intended application either as a DPF, filter in a ventilation system, or the like.

Further, filter housing stand 80 is provided in FIGS. 1 and 4 to adjust the height of filter housing 22. However, in other embodiments stand 80 is not provided and instead, filter housing 22 and its assembled components are configured to be arranged directly on the ground. Filter housing 22 and its assembled components may be oriented vertically, horizontally, or some combination thereof.

In some embodiments, a kit is provided configured to package and transport apparatus 10 with all of its assembled components described herein. The kit is configured for use with conventional shipping crates.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An apparatus for removing particulate from a filter, comprising:
a blower housing a blower fan providing a flow rate;
at least one fluid hose comprising a proximal end and a distal end, wherein the proximal end of the at least one fluid hose is operatively connected to the blower housing;
a nozzle operatively connected to the distal end of the at least one fluid hose;
a filter housing apart from the blower housing and configured to receive the filter, wherein the filter housing is in fluid communication with the nozzle;
a particulate containment mechanism configured directly to the filter housing to receive and store particulate from the filter housing;
a blower filter configured within the blower housing providing additional particulate containment; and
a flow meter configured to measure the flow rate of fluids drawn through the apparatus; wherein the blower housing causes fluids to be drawn through that at least one fluid hose and remove particulate from the filter positioned in the filter housing.

2. (canceled)

3. The apparatus to claim 1, further comprising a particulate removal display configured directly coupled to said nozzle providing indication that particulate has been removed from the filter to a pre-determined level.

4. The apparatus according to claim 3, wherein the particulate removal display is a visual window disposed between the filter housing and the nozzle, and wherein the visual window is configured to provide visual indication that particulate is being removed in real-time.

5. The apparatus according to claim 1, wherein the flow rate is in fluid communication with the filter housing causing the filter housing to become pressurized.

6. The apparatus according to claim 1, the blower filter further comprising:
a cylindrical shape configured around the blower fan; and
a plurality of panels further configured in the cylindrical shape.

7. The apparatus according to claim 1, further comprising a plurality of wheels mechanically attached to the blower housing, and wherein the apparatus is portable.

8. The apparatus according to claim 1, the blower housing further comprising a mesh panel for absorbing gases from the fluids drawn.

9. The apparatus according to claim 1, wherein the filter to be received in the filter housing is a diesel particulate filter.

10. The apparatus according to claim 1, wherein the particulate containment mechanism is a bag.

11. (canceled)

12. An apparatus for removing particulate from a filter, comprising:
a blower housing, the blower housing comprising a mesh panel for absorbing gases from the fluids drawn;
at least one fluid hose comprising a proximal end and a distal end, wherein the proximal end of the at least one fluid hose is operatively connected to the blower housing;
a nozzle operatively connected to the distal end of the at least one fluid hose;
a filter housing apart from the blower housing configured to receive a filter, wherein the filter housing is in fluid communication with the nozzle;
a particulate containment mechanism configured to receive and store caused to be removed by the fluid drawn through the at least one fluid hose; and
a particulate removal display configured to provide indication to a user that particulate has been removed from the filter to a pre-determined level;
wherein the blower housing causes fluids to be drawn through that at least one fluid hose and remove particulate from the filter positioned in the filter housing.

13. The apparatus to claim 12, wherein the blower housing further comprises a motor and blower fan, wherein the motor causes the blower fan to rotate, and wherein rotating the blower fan causes fluids to be drawn through the at least one fluid hose.

14. The apparatus according to claim 13, further comprising a flow meter configured to measure flow rate of fluids drawn through the fluid hose.

15. (canceled)

16. The apparatus according to claim 13, wherein the particulate removal display is a visual window disposed between the filter housing and the nozzle, and wherein the visual window is configured to provide visual indication that particulate is being removed in real-time.

17. A method of removing particulate from a filter, comprising:
providing a blower housing a blower fan;
securely positioning at least one filter in a filter housing;
activating the motor of the blower housing causing fluids to be drawn from the at least one hose through the filter;
removing particulate from the at least one filter with the fluids drawn through that least one hose; and
measuring a flow rate through the at least one hose and determining a sufficiency of particulate removal based on the measuring the flow rate.

18. (canceled)

19. (canceled)
